(19) United States
(12) Patent Application Publication
(10) Pub. No.: US 2011/0185489 A1
(43) Pub. Date: Aug. 4, 2011

(54) RECEPTACLE AND SUPPORT

(75) Inventors: Garry Partington, Lancashire (GB); Wayne Nelson, Greater Manchester (GB)

(73) Assignee: Vernacare Limited, Bolton, Lancashire (GB)

(21) Appl. No.: 13/002,377

(22) PCT Filed: Jul. 1, 2009
(86) PCT No.: PCT/GB2009/050767

§ 371 Date: Apr. 25, 2011

(30) Foreign Application Priority Data
Jul. 2, 2008 (GB) 0812087.5
Dec. 4, 2008 (GB) 0822154.1

(51) Int. Cl. A61G 9/00

(52) U.S. Cl. 4/450

(57) ABSTRACT

A disposable bedpan (10) is releasably mountable on a reusable or disposable annular support (12). The support has inner and outer walls (38, 40) and a plurality of support projections (50) between the inner and outer walls which engage with the under surface of a peripheral lip (28) of the disposable bedpan. The support (12) supports the disposable bedpan (10) in use and prevents collapsing and the soiled disposable bedpan can be disposed of to reduce the risk of cross-infection. When the support is disposable, e.g. made from paper pulp, this can also be disposed of in the macerator.

### The present invention relates to receptacles, e.g. bedpans, and supports therefor and in particular, but not exclusively, to disposable bedpans and supports therefor.

Bedpans are used by bedridden patients in hospitals, nursing homes and the like, where it is not possible for the patient easily to visit a toilet. In order to reduce the risk of cross-infection, the use of disposable bedpans is preferred.

Disposable bedpans are moulded from paper pulp and, after use, can be reduced to small particles in a macerator and then discharged into the normal drainage system.

Disposable bedpans are not self-supporting, since they are made from moulded paper pulp. It is therefore usual to use the disposable bedpan in conjunction with a reusable support in order to prevent collapsing of the disposable bedpan in use.

It is an object of the present invention to provide a reusable or disposable support and disposable bedpan liner which, in combination, permit easier and more comfortable use and which reduces the likelihood of spillage.

In accordance with a first aspect of the present invention, there is provided, in combination, a receptacle adapted to fit on a support, the receptacle comprising a recessed receiving portion having a base and side walls extending upwardly from the base and a seat portion extending at least partially around the periphery of the recessed receiving portion, wherein the support has an open base.

By providing a support with an open base, the receptacle is supported around its periphery in use.

Preferably, the receptacle is adapted to fit into the open base of the support. More preferably, the receptacle is adapted to project partially through the open base of the support. In this way, when the receptacle and support are used on a deformable surface, for example a pressure-relieving mattress, the receptacle itself is in contact with the surface and deforms it, adding to the stability of the combination.

Preferably, the open base of the support forms an opening for receipt of the recessed receiving portion of the support.

The support may comprise base support means for engaging a portion of the base of the receptacle.

In this way, if the bedpan/support combination is used on a relatively soft surface, for example a soft mattress, it is not possible for the the whole of the receiving portion of the bedpan to engage the surface, which might otherwise tend to cause crushing of the side wall of the bedpan as the resilience of the soft surface causes the surface to expand and project into the central aperture of the support, to a level above the lowermost surface of the support.

The base support means may be adapted to support a rear portion of the base wall of the receptacle.

In one embodiment, the lowermost portion of the base support means does not project downwardly past the under surface of the support.

Preferably, the base support means comprises a projection and preferably the projection projects into the opening.

The projection may comprise a lip.

The spacing of the base support means from the upper surface of the support preferably corresponds to the spacing of the portion of the base supported by the base support means from the seat portion of the receptacle.

Preferably, the receptacle is substantially rigid.

Preferably, the receptacle is adapted to fit, at least partially, over the support.

Preferably, the support is annular.

The support preferably comprises a plurality of spaced-apart feet upon which the support can rest.

The support may comprise two side support feet, one located on each side of the support and a rear support foot. Alternatively, or in addition, the support may comprise a further, front support foot.

In one embodiment, the support comprises a plurality of spaced-apart upwardly-extending bedpan support projections adjacent to the periphery of the aperture forming the open base.

Preferably, the bedpan support projections are located around substantially the whole of the periphery of the aperture.

The support may further comprise a reinforcing rib interconnecting a plurality of bedpan support projections, and preferably interconnecting all of the bedpan support projections. The support may comprise an inner wall around the periphery of the aperture forming the open base and an outer wall spaced from the inner wall, the bedpan support projections being located between the inner and outer walls.

The bedpan preferably comprises an outwardly projecting rim engageable with the bedpan support projections.

The outwardly-projecting rim may comprise an upper portion which is upwardly convex in cross section. The upwardly convex upper portion preferably extends around the whole of the periphery of the projecting rim.

The outwardly-extending rim may further comprise a planar, downwardly inclined portion. Preferably, the planar downwardly-inclined portion extends around the whole of the periphery of the outwardly-extending rim. In one embodiment, the downwardly inclined portion forms the outermost portion of the rim.

In accordance with a second aspect of the present invention, there is provided, in combination, a receptacle adapted to fit on a support, the receptacle comprising a recessed receiving portion having a base and side walls extending upwardly from the base and a seat portion extending at least partially around the periphery of the recessed receiving portion, wherein the support comprises a plurality of spaced-apart upwardly-extending bedpan support projections adjacent to its periphery.

Preferably, the bedpan support projections are located around substantially the whole of the periphery of the recess.

The support may further comprise a reinforcing rib interconnecting a plurality of bedpan support projections, and preferably interconnecting all of the bedpan support projections.

The support may comprise an inner wall around the periphery of the recess and an outer wall spaced from the inner wall, the bedpan support projections being located between the inner and outer walls.

The bedpan preferably comprises an outwardly projecting rim engageable with the bedpan support projections.

The outwardly-extending rim may comprise an upper portion which is upwardly convex in cross-section. The upwardly convex upper portion preferably extends around the whole of the periphery of the projecting rim.

The outwardly extending rim may further comprises a planar, downwardly inclined portion. Preferably, the planar, downwardly inclined portion extends around the whole of the periphery of the outwardly-extending rim. In one embodiment, the planar downwardly inclined portion forms the outermost portion of the rim.

Preferably, the seat portion extends around the whole of the periphery of the recessed receiving portion.

Preferably, the receptacle is substantially rigid.

Preferably, the receptacle is adapted to fit, at least partially, over the support.

In one embodiment, the support is annular.

The support may comprise a plurality of spaced-apart support feet on which the support can rest.

The support may comprise two side support feet, are located on each side of the support, and a rear support foot.

The support may further comprise a further, front support foot.

For each of the first and second aspects:

Preferably, the seat portion extends around the whole of the periphery of the recessed receiving portion.

In a preferred embodiment, the support and receptacle comprise a front, narrower portion and a rear, wider portion. Preferably, the narrower front portion and rear wider portion are rounded.

The receptacle preferably comprises a recess adapted to accommodate the coccyx of a user. Alternatively, or in addition, the receptacle may comprise a projection at a front end, adapted to engage with, and position, the thighs of a user.

The base of the receptacle may comprise an inwardly-directed projection adjacent to a front end.

In one embodiment, the uppermost portions of the seat portion lie on a common plane, the base of the receiving portion is substantially planar, and the base of the receiving portion is inclined to the plane of the uppermost portions of the seat portion.

Preferably, the receptacle and support comprise inter-engaging projections and/or recesses for releasably keying the two together.

In a preferred embodiment, the receptacle is disposable and may, for example, be formed from paper pulp. In a preferred embodiment, the receptacle comprises a bedpan.

The support may be reusable or disposable. If disposable, it may be made from paper pulp.

Preferably, the receptacle and support are complementarily-shaped in the regions in which they engage each other.

In accordance with a third aspect of the present invention, a support for a receptacle comprises an aperture forming an open base for receipt of the receptacle and receptacle support portions adjacent to the periphery of the aperture.

Preferably, the support portions are located around substantially the whole periphery of the aperture.

In one embodiment, the support portions comprise a plurality of spaced-apart, upwardly-projecting receptacle support portions.

The support preferably further comprises a reinforcing rib interconnecting a plurality of receptacle support projections. Preferably, the reinforcing rib interconnects all of the receptacle support projections.

In one embodiment, the support comprises an inner wall around the periphery of the aperture and an outer spaced from the inner wall, the receptacle support projections being located between the inner and outer walls.

The support portions may be substantially continuous.

Preferably, the support has a closed cross-section.

The support may comprise a plurality of spaced-apart support feet on which the support can rest. For example, the support may comprise two side support feet, one located on each side of the support, and a rear support foot. Alternatively, or in addition, the support may comprise a further, front support foot.

The recess may comprise an aperture forming an open base for receipt of a receptacle.

In one embodiment, the support is annular.

In accordance with a fourth aspect of the present invention, there is provided a support for a receptacle, comprising a recess for receipt of the receptacle and a plurality of spaced-apart upwardly-extending receptacle support portions adjacent to the periphery of the recess.

Preferably, the support portions are located around substantially the whole periphery of the recess.

Preferably, the support portions comprise a plurality of spaced-apart, upwardly-projecting receptacle support portions.

The support may further comprise a reinforcing rib interconnecting a plurality of receptacle support projections. Preferably, the reinforcing rib interconnects all of the receptacle support projections.

In one embodiment, the support comprises an inner wall around the periphery of the aperture and an outer wall spaced from the inner wall, the receptacle support portions being located between the inner and outer walls.

Preferably, the support has a closed cross-section.

The support may comprise a plurality of spaced-apart support feet on which the support can rest. For example, the support may comprise two side support feet, one located on each side of the support, and a rear support foot. Alternatively, or in addition, the support may comprise a further, front support foot.

The recess may comprise an aperture forming an open base for receipt of a receptacle.

In one embodiment, the support is annular.

In accordance with a fifth aspect of the invention, a support for a receptacle comprises a plurality of spaced-apart support feet upon which the support can rest.

In one embodiment, the support comprises two side support feet, one located each side of the support, and a rear support foot.

The support may further comprise a further, front support foot.

The support preferably comprises an aperture forming an open base for receipt of a receptacle. More preferably, the support is annular.

In accordance with a sixth aspect of the present invention, a receptacle comprises a recessed receiving portion having a base and side walls extending upwardly from the base and a seat portion extending at least partially around the periphery of the recessed receiving portion, the seat portion comprising an outwardly-extending rim having an upper portion which is upwardly convex in cross-section.

This aids in the positioning of a user onto the receptacle. Preferably, the outwardly-extending rim extends around the whole of the periphery of the recessed receiving portion.

Preferably, the upwardly convex portion of the outwardly-extending rim also extends around the whole of the periphery of the rim.

The rim may further comprise a planar, downwardly-inclined portion located outwardly of the upwardly convex seat portion.

The planar, downwardly inclined portion preferably comprises the outermost portion of the rim.

The planar, downwardly inclined portion preferably extends around the whole of the periphery of the rim.

Preferably, the receptacle comprises a bedpan.

In accordance with a seventh aspect of the present invention, a receptacle comprises a recessed receiving portion having a base and side walls extending upwardly from the base and a seat portion extending at least partially around the periphery of the recessed receiving portion, the seat portion comprising an outwardly-extending rim having a planar, downwardly extending portion extending around at least part of the rim.

This also aids in the positioning of a user on the receptacle.

Preferably, the planar, downwardly-inclined outermost portion extends around the whole of the periphery of the rim. More preferably, the rim extends around the whole periphery of the recessed receiving portion.

In one embodiment, the planar, downwardly-extending portion of the rim forms the outermost portion of the rim.

The seat portion may comprise an upper portion which is upwardly convex in cross-section, located inwardly of the planar, downwardly inclined portion.

Preferably, the upwardly convex portion extends around the whole of the periphery of the recessed receiving portion.

Preferably, the receptacle comprises a bedpan.

Preferably, the seat portion further comprises a recess for receipt of the coccyx of a user.

The receptacle may further comprise a thigh-positioning lug at a front end of the receptacle.

By way of example only, specific embodiments of the present invention will now be described, with reference to the accompanying drawings, in which:-

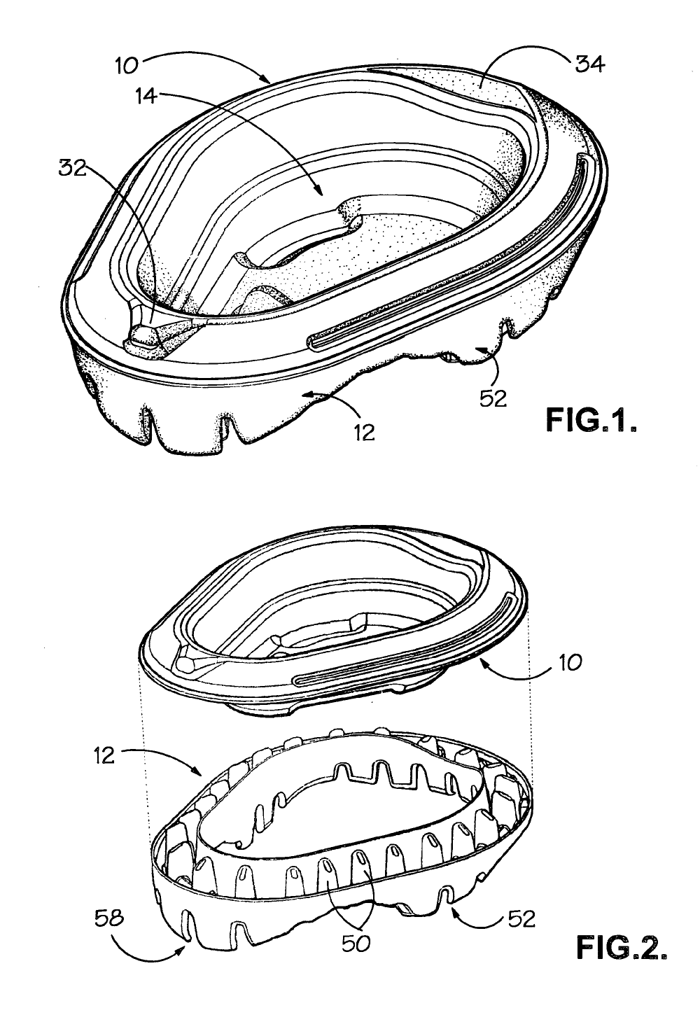

FIG. 1 is a perspective view of an embodiment of disposable bedpan in combination with a disposable support;

FIG. 2 is an exploded view of the combination illustrated in FIG. 1;

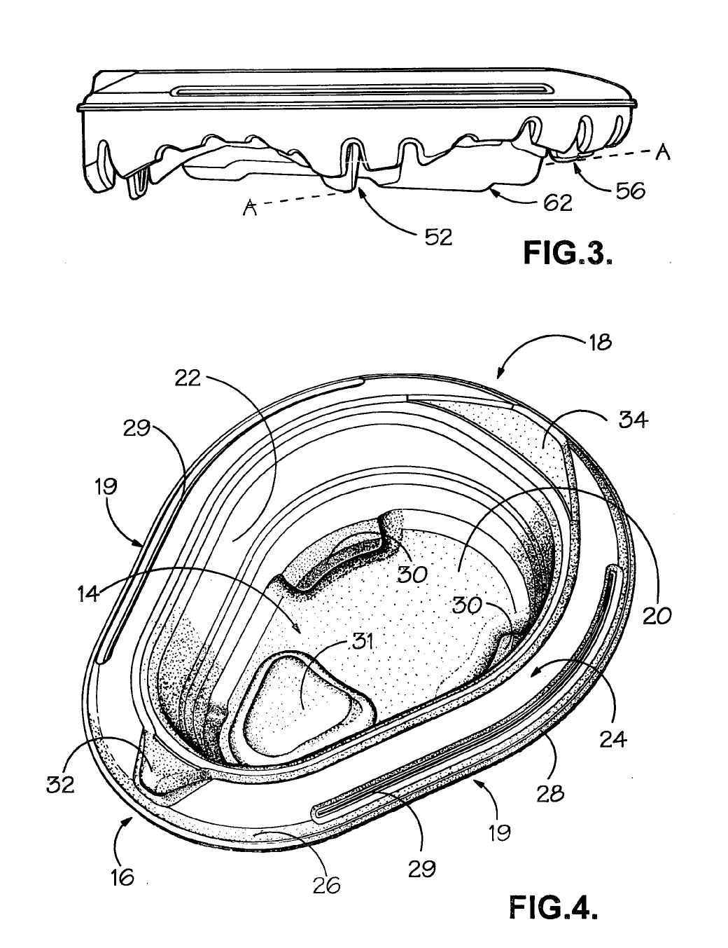

FIG. 3 is a side view of the combination of FIG. 1;

FIG. 4 is a perspective view from above of the disposable bedpan of the combination of FIG. 1;

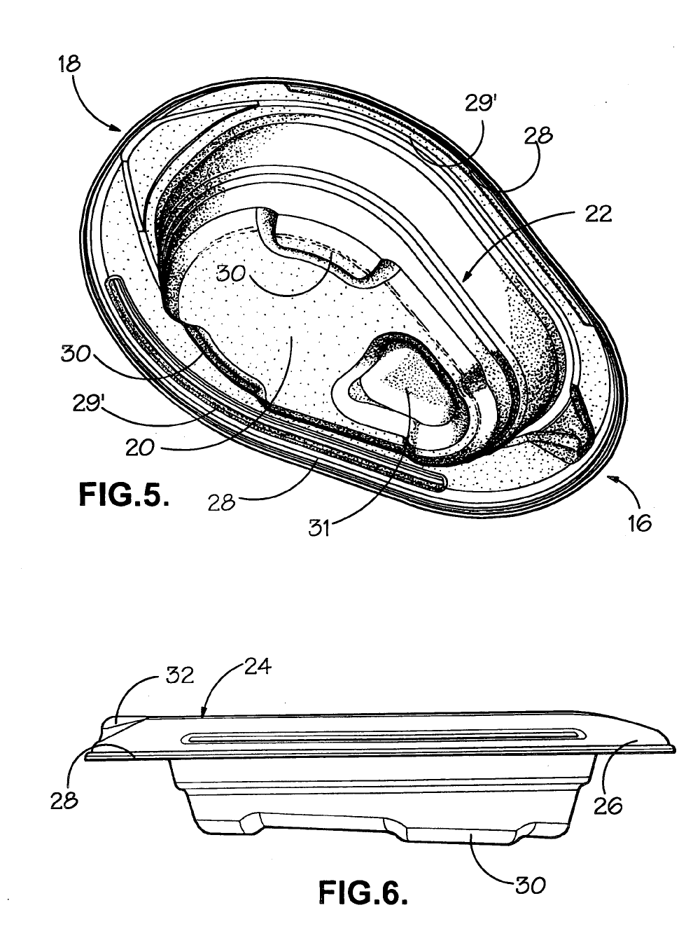

FIG. 5 is a perspective view from below of he disposable bedpan of the combination of FIG. 1;

FIG. 6 is a side view of the disposable bedpan of the combination of FIG. 1.

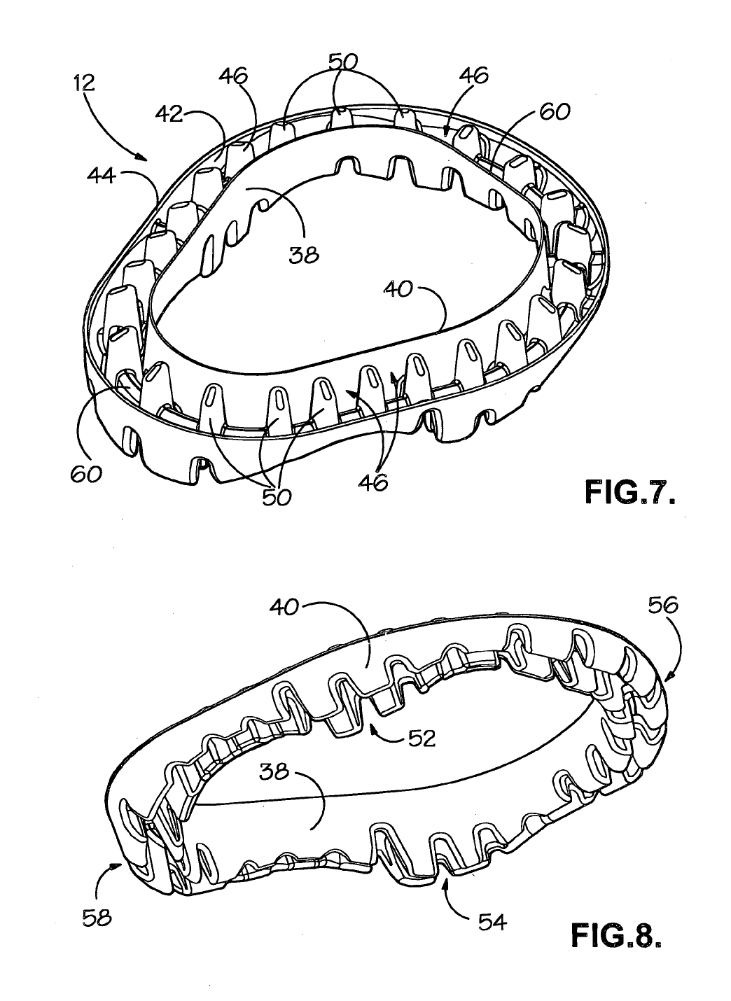

FIG. 7 is a perspective view from above of the support of the combination of FIG. 1;

FIG. 8 is a perspective view from below of the support of the combination of FIG. 1;

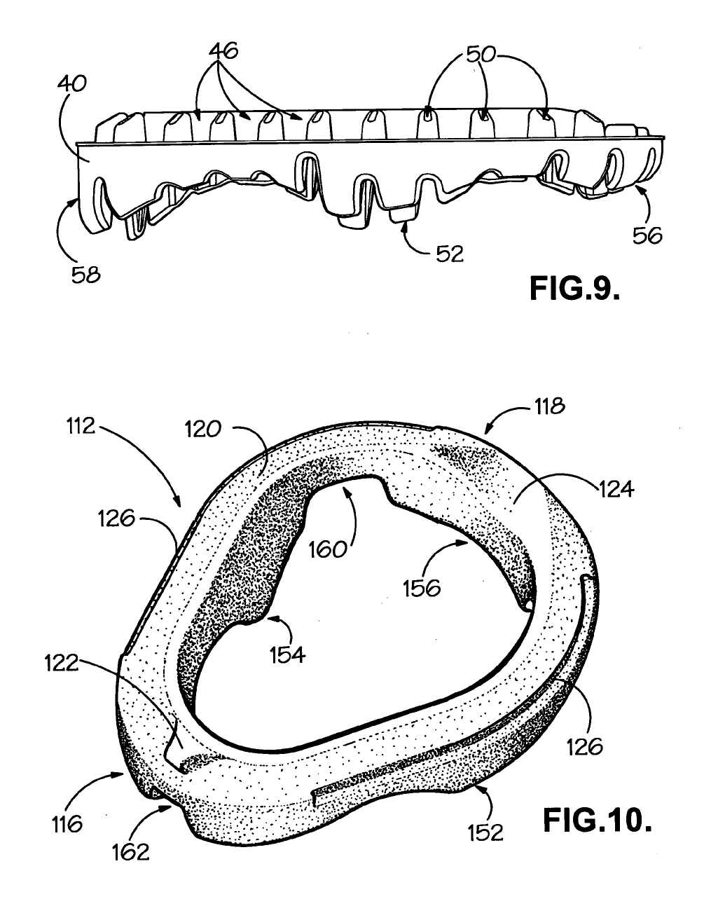

FIG. 9 is a side view of the support of the combination of FIG. 1;

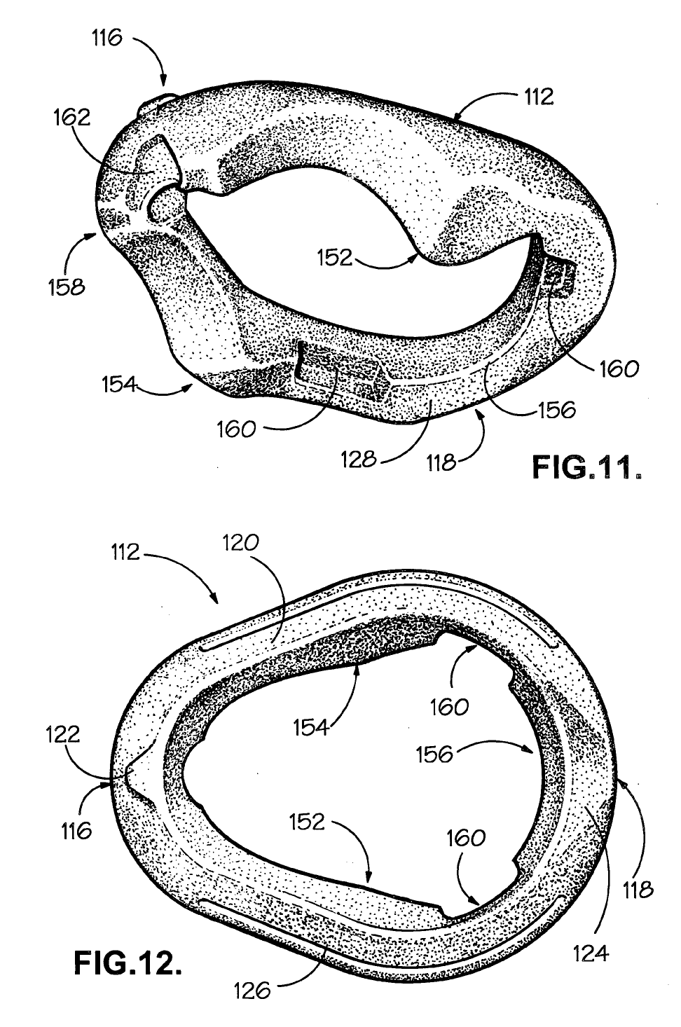

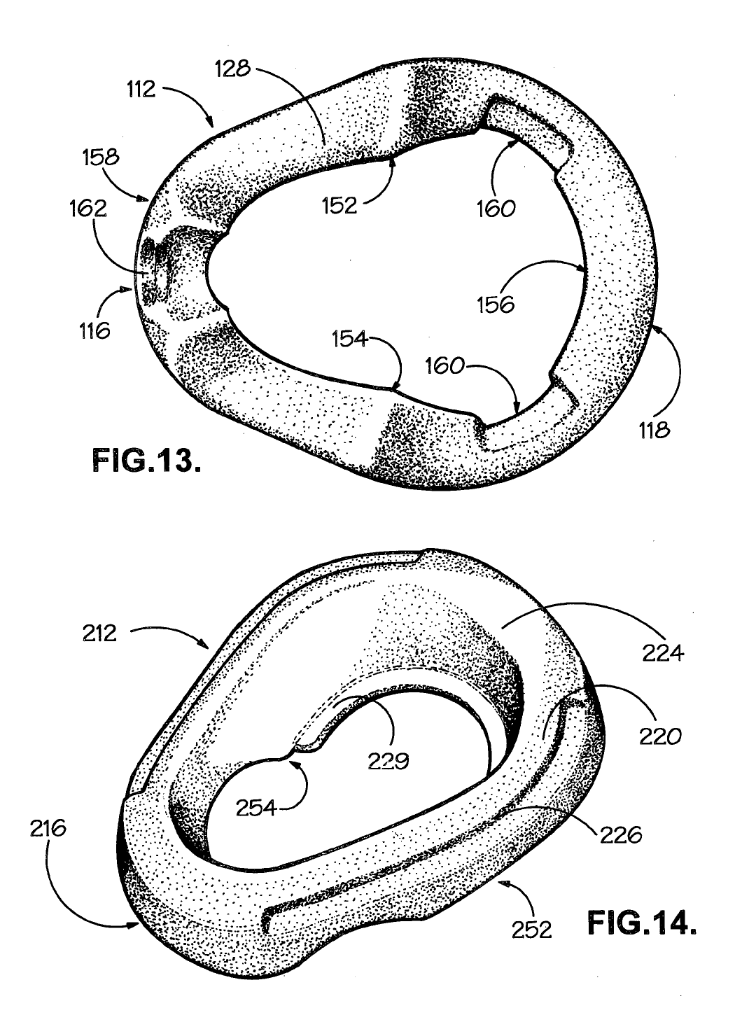

FIGS. 10 to 13 are, respectively, a perspective view from above, a perspective view from below, a view from above and a view from below of a first embodiment of reusable support which can be used in place of the disposable support of FIGS. 1 to 3 and 7 to 9; and

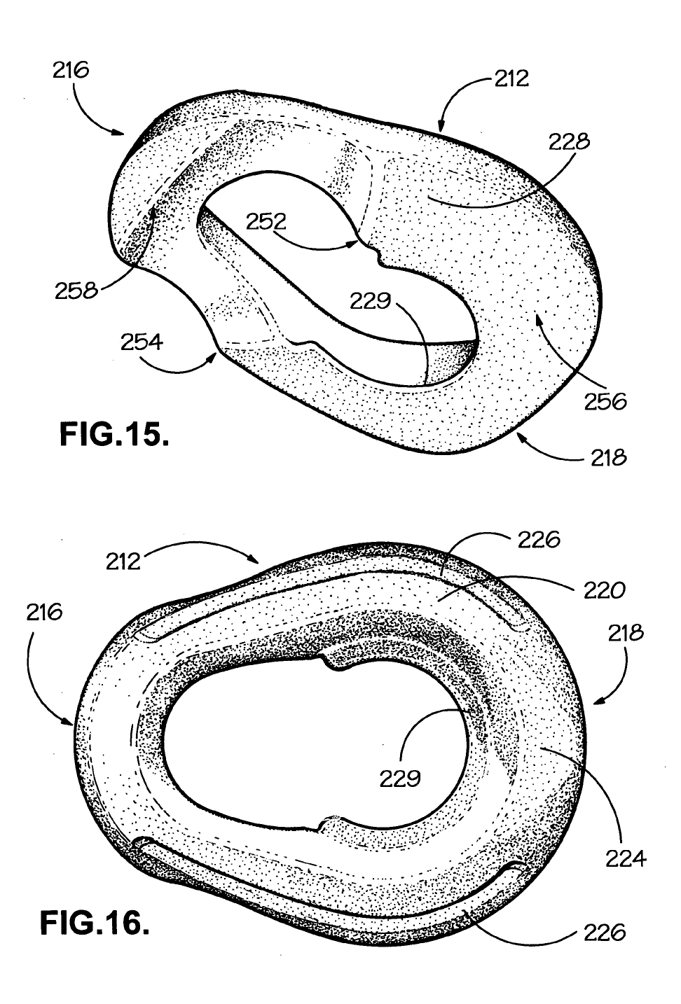

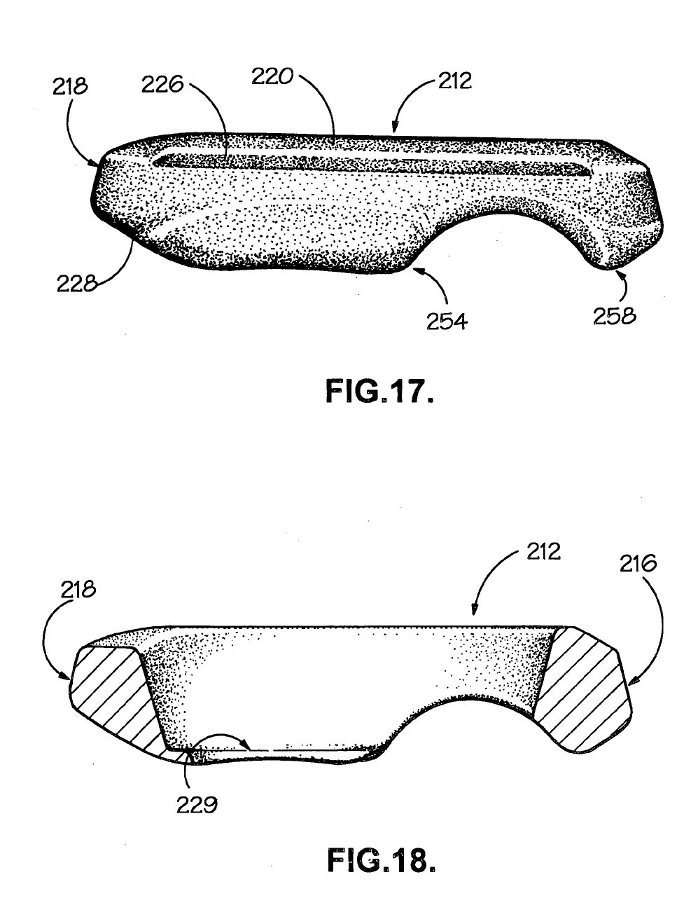

FIGS. 14 to 18 are, respectively, a perspective view from above, a perspective view from below, a view from above, a view from the side and a longitudinal cross-section of a second embodiment of reusable support which can be used in place of the disposable support of FIGS. 1 to 3 and 7 to 9.

FIGS. 1 to 9 illustrate a disposable bedpan 10 which is used in conjunction with a disposable support 12. As indicated in FIGS. 1 to 3, the bedpan 10 is releasably mountable on the support 12 in use and is removed and disposed of after use.

As best seen in FIGS. 4 to 6, the disposable bedpan 10 is substantially rigid and is moulded from paper pulp and comprises a generally teardrop-shaped receiving portion 14 having a rounded narrower front end 16 and a wider rounded rear end 18, the two ends being joined by straight sides 19. The receiving portion 14 also has a generally planar base 20 and side walls 22 extending upwardly and outwardly from the base 20.

The upper portions of the side walls 22 merge into a tear drop-shaped peripheral annular seating portion 24 extending around the whole of the periphery of the receiving portion 14. As shown in FIGS. 1 to 6, the upper surface of the peripheral annular seating portion 24 is rounded when viewed in cross-section and its outermost peripheral edge is formed into an inclined peripheral face 26 which, as will be explained, facilitates use of the bedpan.

As seen in FIGS. 3 and 6, the uppermost portions of the upper surface of the seating portion 24 lie in the same plane (the “seating plane”). However, it will be noted that the planar base wall 20 is not parallel to the seating plane, but instead is inclined upwardly slightly (approximately 3°) towards the front, narrower end 16, whereby the receiving portion is slightly deeper at the rear end 18 than at the front end 16.

As illustrated in FIGS. 4 to 6, the peripheral annular seating portion 24 forms an overhanging peripheral lip 28 around the entire periphery of the bedpan which, as will be explained, engages with a corresponding portion of the support 12. Each side of the seating portion 24 is also formed into a locating groove 29 extending from the front narrow end 16, along the straight side portion and partially around the wider rear end 18. The locating grooves form complementarily shaped projections 29′ on the under surface of the seating portion which engage with the support, as will be explained.

It will also be observed that the base wall 20 of the receiving portion 14 comprises an inwardly-projecting, flat-topped, generally triangular projection 31 towards the front, narrower rounded end 16 of the base wall 20, to act as a “breakwater” in order to reduce splashing. The base wall 20 is also provided with two downwardly projecting lugs 30 which act as support feet for the liner, as will be explained. The lugs are located one on each side of the bedpan, at the junction of the straight portions of the side walls 22 and the larger rounded end portion 18.

It will also be noted that the upper surface of the front, narrower end 16 of the annular seat portion 24 is formed into an upwardly-projecting lug 32. The upper surface of the lug is shaped to engage the inner thigh portions of a user, in order to position the patient correctly on the bedpan. The opposite, wider end 24 of the annular seat portion is provided with a recess 34 for receipt of the coccyx of a user, for comfort.

The disposable support 12 is annular, namely it forms a complete ring and is complementarily shaped with the shape of the bedpan, namely with a narrower front end, a wider rear end and straight side walls interconnecting the front and rear ends. The support 12 is moulded from paper pulp and comprises an upstanding inner wall 38 extending around the whole of the upper inner periphery of the aperture forming the annular support. The upper peripheral edge 40 of the inner wall 38 is adapted to engage with the inner face of the overhanging peripheral lip 28 of the disposable bedpan 10. The support 12 also comprises an upstanding peripheral outer wall 42 extending around the whole periphery of the support, whose upper edge 44 is adapted, in use, to engage with the edge of the downturned peripheral lip 28 of the disposable bedpan. It will be seen from FIGS. 1 to 3 that when the disposable bedpan 10 is positioned on the support 12, the edge of the downturned peripheral lip 28 of the bedpan engages smoothly with the upper edge 44 of the outer upstanding peripheral wall 42 of the support 12, thereby presenting a smooth interface for a user.

The inner and outer upstanding peripheral walls 38, 42 of the support are joined at their lowermost edges. However, it will also be observed that the under surface of the support is formed into a series of spaced-apart recesses 46, and projections between the recesses, which form a series of spaced-apart lugs 50 projecting upwardly into the gap between the inner and outer upstanding walls. The upper surfaces of the lugs 50 are complementarily shaped with, and adapted to engage and support, the under surface of the overhanging peripheral lip 28 of the disposable bedpan.

As best seen in FIG. 9, the lowermost surface of the support is not flat but instead the periphery is formed into four support feet 52, 54, 56, 58, one 52, 54 on either side of the support located where the straight sides meet the larger rear end 18, one 56 located at the rear 18 of the support and one 58 located at the narrower front end 16 of the support. In use, the support 12 is adapted to rest on three of the four feet portions (the two side feet 52, 54 and either the front or rear foot 56, 58) as will be explained.

It will also be noted from FIG. 7 that the support lugs 50 are joined by a peripheral rib portion 60 extending around the entire periphery of the support.

In use, a disposable bedpan is fitted onto a support 12, as shown in FIG. 1. The bedpan and support are complementarily shaped, i.e. they are shaped to fit together, in the regions in which they engage each other. As explained previously, the under surface of the overhanging seating portion engages with the upper ends of the support lugs. In particular, the two locating grooves fit into the gap between the outer wall 42 and the upstanding lugs 50 of the support 12. In addition, the outer peripheral edge of the seating portion 24 engages with the upstanding peripheral edge 44 of the outer wall 42 of the support and the laterally innermost portions of the under surface of the seating portion 24 engage with the upper edge 40 of the inner wall 38 of the support.

It will be noted from FIG. 3 that when the bedpan 10 is fitted onto the support 12, the bedpan projects beyond the lowermost portions of the support. In particular, the rearmost portion 62 of the bedpan in the vicinity of the intersection of the base wall 20 and side walls 22 project beyond the plane A-A on which the lowermost portions of the rear support foot 56 and the two side support feet 52, 54 lie. It will also be noted that the base 20 of the bedpan slopes rearwardly when positioned on the support 12, both when the support rests on the front support foot 58 and the side support feet 52, 54 and when it rests on the rear support foot 56 and the two side support feet 52, 54.

The assembled bedpan 10 and support 12 is then positioned on the upper surface of the mattress of a bed where it is required. The normal procedure would be to roll a patient onto one side and to position the bedpan up against the patient's posterior. The patient and the bedpan and support are then rolled back onto the mattress. This is facilitated by the inclined peripheral face 26 and the rounded upper face of the seating portion 24 of the disposable bedpan. The patient is thereby positioned on the assembled bed pan and support. The recess 34 at the rear rounded end 18 of the disposable bedpan accommodates the user's coccyx and ensures that the patient's weight is not borne by the coccyx.

Similarly, the projecting lug 32 at the opposite, narrower end 16 of the disposable bedpan engages the inner portions of a user's thighs and assists in positioning the user correctly on the bedpan and improves the user's comfort, thereby aiding the confidence of the user.

When a user is in position on the assembled bedpan and support, the user's weight will tend to be concentrated towards the wider rounded rear end 18. Consequently, the assembled bedpan and support will tend to tilt rearwardly, until supported by the two side feet 52, 54 and the rear foot 56 of the support 12. Since the bedpan and support will be used when a user is on a mattress, the weight of the user causes the support feet 52, 54, 56 to sink into the mattress. Similarly, the projecting portion 62 of the disposable bedpan, which projects beyond the feet 52, 54, 56 also sinks into the mattress. This results in a very stable support of reduced height and adds to the confidence of a user. However, the majority of the weight of the user is still born by the support 12 via the support feet 52, 54, 56.

It will also be noted that the base wall 20 of the bedpan slopes rearwardly, which results in liquid within the bedpan 10 collecting at its wider, rear end.

It will be appreciated that although the user will be in contact with the annular peripheral seating portion 24 of the disposable bedpan, the majority of the weight of the user will be borne by the support 12, via the inner and outer upstanding walls 38, 42 and particularly via the upstanding lugs 50 located between the inner and outer upstanding walls.

Moreover, in view of the fact that the support is provided with spaced-apart feet 52, 54, 56, there will be a tendency for the assembled bedpan and support to sink into a mattress at those spaced-apart locations and at the projecting portion 62 of the bedpan. In contrast, if the base of the support were at the same level, the weight borne by the support would tend to be spread more evenly. By providing a plurality of spaced-apart support feet, which results in the feet sinking into the mattress, a firmer and more secure base is achieved.

After use, the user can be temporarily rolled off the bedpan 10 and the bedpan 10 and support 12 can then be removed, whereupon the patient can then be rolled back into position on the mattress. The disposable bedpan 10 can then be removed from the support 12 for disposal in a macerator. If the support is made form paper pulp this may also be disposed of in the macerator.

However, it is often the case that it is not possible to dispose of a soiled bedpan immediately, in which case it may be necessary to leave the assembled bedpan and support to one side for a short while. The support is designed to rest also on the two side feet 52, 54 and the front foot 58. Consequently, the reusable bedpan is the main aspect of the bedpan/support assembly which comes into contact with the mattress. This reduces the risk of cross-infection or contamination problems which can be present with supports which have a base covering all of the base of the disposable bedpan, i.e. non-annular supports.

FIGS. 10 to 13 illustrate a first embodiment of reusable support which can be used instead of the disposable support 12 of FIGS. 1 to 3 and 7 to 9. The reusable support is of generally the same shape, dimensions and profile as the disposable support, as it designed to co-operate with the bedpan 10 in an identical manner to the disposable support. However, the reusable version 112 is made from stronger material, e.g. a plastics material such as polypropylene, and therefore does not require the same degree of reinforcement as the disposable version, e.g. the spaced apart lugs 50.

The reusable support 112 is also annular, namely it forms a complete ring. In contrast to the disposable version, the support 112 is hollow and enclosed, namely it has a closed cross-section, and thereby forms a continuous outer surface which is sealed with respect to the interior of the ring. The support 112 may, for example, be made by a blow-moulding process.

The reusable support 112 comprises an upper face 120 which is complementarily shaped to the shape of the under surface of the seating portion 24 of the bedpan 10, whereby the upper face 120 of the support and the under surface of the seating portion are in substantially continuous contact with each other. In this way, the weight of a user is spread more evenly over the support. In particular, it will be noted that the front and rear ends of the support 112 are provided with a projection 122 and a recess 124 respectively, corresponding to the thigh-engaging lug 32 and the coccyx-receiving recess 34 of the bedpan 10 and the sides of the upper face of the support are provided with recesses 126 corresponding to, and receiving in use, the locating groove portions 29 of a bedpan 10.

As mentioned above, and as seen in FIGS. 10 to 13, the upper face 120 of the support merges smoothly into the under surface 128 of the support. As for the disposable support, the support 112 is provided with four support feet 152, 154, 156, 158 the two support feet 152, 154 being located one on either side of the support where the straight sides of the support meet the larger rear end 118, one foot 156 located at the rear end 118 of the support and one foot 158 located at the narrower front end 116 of the support. The size, shape and location of the feet are identical to the feet of the disposable support and the support is therefore able to rest on the two side feet 152, 154 and either the rear foot 156 or the front foot 158.

It will also be noted that the under surface 128 is provided with two recesses 160, one located immediately to the rear of each side foot 152, 154, to provide a grip facility in order to aid lifting and removal of the support, particularly when supporting a used bedpan. A recess 162 is also provided in the front face of the support at the narrower front end 116. This allows a user to insert a finger underneath the edge of the front portion 16 of a bedpan 10 positioned on the support 112 in order to facilitate removal of the bedpan from the support.

It will be observed that the upper surface 120 and under surface 128 of the support do not have the recesses 46 and projections 50 of the disposable support but instead are smooth and rounded, in order to minimise the number of locations where potentially harmful material such as bacteria and viruses can lodge and to facilitate thorough cleaning and drying of the reusable support

The reusable support 112 is used in an identical manner to the disposable support 12, with the exception that, after use, the reusable support is cleaned for reuse rather than being discarded and disposed of.

FIGS. 14 to 18 illustrate a second embodiment of reusable support which can be used instead of the disposable support 12 of FIGS. 1 to 3 and 7 to 9. The reusable support is of generally the same shape, dimensions and profile as and is also designed to cooperate with the bedpan 10 in an identical manner to the disposable support. In the following description of FIGS. 14 to 18, the same reference numerals used in connection with the embodiment of FIGS. 10 to 13 are used to refer to the same features, with the first digit “1” being replaced with “2”. As for the embodiment of FIGS. 10 to the 13, the embodiment of FIGS. 14 to 18, denoted by reference numeral 212, is made from stronger material, e.g. a plastics material such as polypropylene, and therefore does not require the same degree of reinforcement as the disposable version, e.g. the spaced apart lugs 50.

The reusable support 212 is very similar in shape and dimensions to the reusable support 112 of FIGS. 10 to 13. In particular, the support 212 is also annular, namely it forms a complete ring. As for the embodiment of FIGS. 10 to 13, the support 212 is hollow and enclosed, namely it has a closed cross-section (as can be seen from the cross-section of FIG. 18), and thereby forms a continuous outer surface which is sealed with respect to the interior of the ring. The support 212 may, for example, be made by a blow-moulding process.

The reusable support 212 comprises an upper face 220 which is complementarily shaped to the shape of the under surface of the seating portion 24 of the bedpan 10, whereby the upper face 220 of the support and the under surface of the seating portion are in substantially continuous contact with each other. In this way, the weight of a user is spread more evenly over the support. In particular, it will be noted that the rear end of the support 212 is provided with a recess 224, corresponding to the coccyx-receiving recess 34 of the bedpan 10 and the sides of the upper face of the support are provided with recesses 226 corresponding to, and receiving in use, the locating groove portions 29 of a bedpan 10.

However, it will be observed that the projection 122 of the previous embodiment, located at the front end of the support, has been omitted.

As for the embodiment of FIGS. 10 to 13, and as seen in FIGS. 14 to 18, the upper face 220 of the support merges smoothly into the under surface 228 of the support. As for the disposable support, the support 212 is provided with four support feet 252, 254, 256,258 the two support feet 252, 254 being located one on either side of the support where the straight sides of the support meet the larger rear end 218, one foot 256 located at the rear end 218 of the support and one foot 258 located at the narrower front end 216 of the support. The size, shape and location of the feet are identical to the feet of the disposable support and the support is therefore able to rest on the two side feet 252, 254 and either the rear foot 256 or the front foot 258.

It will also be noted that the under surface 228 of the support 212 omits the two recesses 160, one located immediately to the rear of each side foot 152, 154, and also omits the recess 162 in the front face of the support at the narrower front end 116, of the embodiment of FIGS. 10 to 13.

However, in contrast to the previous embodiment, the under surface 228 of the support is formed into an inwardly-directed flat lip 229 around the opening in the base of the support. The lip is located at the rear of the support and extends from where the straight sides of the support meet the larger rear end 218, around the curved rear end of the support. As can be seen from the drawings, the lip 229 projects inwardly from the base of the interior side wall which extends between the upper face 220 and the under surface 228 and the lower face of the lip is at the same level as, and merges smoothly with, the under surface 228. The lip is designed to engage with, and thereby support, the rearmost and lowermost curved portion of the receiving portion 14 of a disposable bedpan 10 at the junction of the side wall 22 and the base 20.

The spacing of the lip 229 from the upper face 220 of the support corresponds to the spacing of the seating portion 24 from the rearmost and lowermost curved portion of the receiving portion 14 of a disposable bedpan 10. In this way, it is not possible for the rearmost portion of the bedpan to project through the central aperture of the support. Consequently, if the bedpan/support combination is used on a relatively soft surface, for example a soft mattress, is it not possible for the rearmost and lowermost curved portion of the receiving portion 14 of the bedpan 10 to engage the surface, which might otherwise tend to cause crushing of the side wall of the bedpan as the resilience of the soft surface causes the surface to expand and project into the central aperture of the support, to a level above the lowermost surface of the support.

As for the previous embodiment, the upper surface 220 and under surface 228 of the support do not have the recesses 46 and projections 50 of the disposable support but instead are smooth and rounded, in order to minimise the number of locations where potentially harmful material such as bacteria and viruses can lodge and to facilitate thorough cleaning and drying of the reusable support.

The reusable support 212 is used in an identical manner to the reusable support 112 of the previous embodiment, the bedpan and support being complementarily shaped, i.e. they are shaped to fit together, in the regions in which they engage each other.

The invention is not restricted to the details of the foregoing embodiments. In particular, it is not necessary to form the bedpan from moulded paper pulp material or for the bedpan to be disposable. Instead, it would be possible to design the bedpan so that it is reusable. For example, it would be possible to form the bedpan from plastics material. In that case, the bedpan could be used by itself and it would not be necessary (although it would still be possible) for it to be used in conjunction with a support 12, 112, 212.

1.-100. (canceled)

101. A receptacle adapted to fit on a support, the receptacle comprising:
a recessed receiving portion having a base and side walls extending upwardly from the base; and
a seat portion extending at least partially around the periphery of the recessed receiving portion, wherein the support has an open base.

102. The receptacle as claimed in claim 101, wherein the receptacle is adapted to fit into the open base of the support.

103. The receptacle as claimed in claim 102, wherein the receptacle is adapted to project partially through the open base of the support.

104. The receptacle as claimed in claim 101, wherein the open base of the support forms an opening for receipt of the recessed receiving portion of the support.

105. The receptacle as claimed in claim 104, wherein the support comprises base support means for engaging a portion of the base of the receptacle.

106. The receptacle as claimed in claim 105, wherein the base support means is adapted to support a rear portion of the base wall of the receptacle.

107. The receptacle as claimed in claim 105, wherein the lowermost portion of the base support means does not project downwardly past the under surface of the support.

108. The receptacle as claimed in claim 105, wherein the base support means comprises a projection.

109. The receptacle as claimed in claim 108, wherein the projection projects into the opening.

110. The receptacle as claimed in claim 108, wherein the projection comprises a lip.

111. The receptacle as claimed in claim 105, wherein the spacing of the base support means from the upper surface of the support corresponds to the spacing of the portion of the base supported by the base support means from the seat portion of the receptacle.

112. The receptacle as claimed in claim 101, wherein the receptacle is substantially rigid.

113. The receptacle as claimed in claim 101, wherein the receptacle is adapted to fit, at least partially, over the support.

114. The receptacle as claimed in claim 101, wherein the support is annular.

115. The receptacle as claimed in claim 101, wherein the support comprises a plurality of spaced-apart support feet on which the support can rest.

116. The receptacle as claimed in claim 115, further comprising:
two side support feet that are located on each side of the support; and
a rear support foot.

117. The receptacle as claimed in claim 116, further comprising:
a further, front support foot.

118. The receptacle as claimed in claim 101, wherein the support comprises a plurality of spaced-apart upwardly-extending bedpan support projections adjacent to the periphery of the aperture forming the open base.

119. The receptacle as claimed in claim 118, wherein the bedpan support projections are located around substantially the whole of the periphery of the aperture.

120. The receptacle as claimed in claim 118, further comprising:
a reinforcing rib interconnecting a plurality of bedpan support projections.

121. The receptacle as claimed in claim 120, wherein the reinforcing rib interconnects all of the bedpan support projections.

122. The receptacle as claimed in claim 118, further comprising:
an inner wall around the periphery of the aperture forming the open base; and
an outer wall spaced from the inner wall, the bedpan support projections being located between the inner and outer walls.

123. The receptacle as claimed in claim 118, wherein the bedpan comprises an outwardly projecting rim engageable with the bedpan support projections.

124. The receptacle as claimed in claim 123, wherein the outwardly-extending rim comprises an upper portion which is upwardly convex in cross-section.

125. The receptacle as claimed in claim 124, wherein the upwardly convex upper portion extends around the whole of the periphery of the projecting rim.

126. The receptacle as claimed in claim 123, wherein the outwardly extending rim further comprises a planar, downwardly inclined portion.

127. The receptacle as claimed in claim 126, wherein the planar, downwardly inclined portion extends around the whole of the periphery of the outwardly-extending rim.

128. The receptacle as claimed in claim 127, wherein the planar downwardly inclined portion forms the outermost portion of the rim.

129. The receptacle as claimed in claim 101, wherein the seat portion extends around the whole of the periphery of the recessed receiving portion.

130. The receptacle as claimed in claim 101, wherein the support and receptacle comprise a front, narrower portion and a rear, wider portion.

131. The receptacle as claimed in claim 130, wherein the narrower front portion and rear wider portion are rounded.

132. The receptacle as claimed in claim 101, wherein the receptacle comprises a recess adapted to accommodate the coccyx of a user.

133. The receptacle as claimed in any claim 101, wherein the receptacle further comprises a projection at a front end, adapted to engage with and position the thighs of a user.

134. The receptacle as claimed in claim 101, wherein the base of the receptacle further comprises an inwardly-directed projection adjacent to a front end.

135. The receptacle as claimed in claim 101, wherein the uppermost portions of the seat portion lie on a common plane, the base of the receiving portion is substantially planar and wherein the base of the receiving portion is inclined to the plane of the uppermost portions of the seat portion.

136. The receptacle as claimed in claim 101, wherein the receptacle and support comprise interengaging projections and/or recesses for releasably keying the two together.

137. The receptacle as claimed in claim 101, wherein the receptacle is disposable.

138. The receptacle as claimed in claim 137, wherein the receptacle is formed from paper pulp.

139. The receptacle as claimed in claim 101, wherein the receptacle comprises a bedpan.

140. The receptacle as claimed in claim 101, wherein the support is reusable or disposable.

141. The receptacle as claimed in claim 101, wherein the receptacle and support are complementarily shaped in the regions in which they engage each other.
